(19) United States
(12) Patent Application Publication
(10) Pub. No.: US 2025/0383192 A1
(43) Pub. Date: Dec. 18, 2025

(54) CAPACITIVE DISTANCE SENSOR FOR MEASURING THE THICKNESS OF POWDER AND INHOMOGENEOUS MATERIAL LAYERS

(71) Applicant: Gregory Peter Martiska, Newtown, CT (US)

(72) Inventor: Gregory Peter Martiska, Newtown, CT (US)

(73) Assignee: Mercury Scientific Inc., Newtown, CT (US)

(21) Appl. No.: 18/744,669

(22) Filed: Jun. 16, 2024

(51) Int. Cl. G01B 7/06

(52) U.S. Cl. CPC G01B 7/085

(57) ABSTRACT

A capacitive sensor is provided for measuring the thickness of powder layers created by powder spreading machines across a variety of applications and for measuring the thickness of inhomogeneous materials. The sensor consists of two or more measuring electrode pairs that are at different distances from the powder layer or material of interest. The measuring electrode pairs are used in combination to measure the distance to the surface of the powder layer or material of interest independent of the density and material composition of the powder layer or material of interest.

### CROSS-REFERENCE TO RELATED APPLICATIONS

Not Applicable

### BACKGROUND OF THE INVENTION

### 1) Field of the Invention

This invention relates to a capacitive sensor to measure the thickness of powder layers created by powder spreading machines across a variety of applications and for measuring the thickness of inhomogeneous materials. The information produced by these measurements can determine how well a powder performs in spreading operations and if a process is creating the correct thickness of solid but inhomogeneous materials and films. The thickness of powder layers in industrial applications is typically on the micrometer level.

### 2) Description of the Related Art

The thickness of an object can be determined by placing the object on a table and measuring the distance between the object's top surface and a position at a known height above object and table. The thickness of the object is the known height above the table minus the distance from the known height to the object's surface. This process is automated by placing a distance sensor at the known height. The distance sensor measures the distance to the top surface of the object. For this measurement to be accurate, the distance sensor should respond only to the distance between the top surface of the object and the sensor. For the ideal sensor, the distance measurement is not affected by the properties of the object being measured. The object properties include the material composition of the object, the density of the material, and the smoothness of the object's surface. If the object properties have an effect on the distance measurement, then these effects are compensated for to make an accurate measurement.

Most if not all distance sensors are affected by the properties of the object being measured. This is acceptable when the object properties are constant because the effect of a property can be compensated for through measurement calibration. This is not acceptable for powder layers and inhomogeneous materials that have properties that are not constant. For example, the density of a powder layer in additive manufacturing printer is not constant and varies with location.

A common and inexpensive distance sensor used for measuring the micrometer thickness of materials is a capacitive distance sensor. Capacitive distance sensors use an electrode pair to measure changes in capacitance as the sensors near an object of interest. Capacitive distance sensors that use a conductive plate as a capacitive sensing electrode and a ground source to precisely measure the distance to a target object are widely known. One of the most common types of capacitive sensors is based on measuring the capacitance between a capacitive sensing electrode and a grounded target object or material of interest which serves as the ground source. As the target object or material of interest nears the capacitive sensing electrode the capacitance of the sensor changes. The capacitance is measured by a capacitive sensing circuit of which there are many commercial variants. The change in capacitance depends on the type and amount of material in the sensing zone. The distance to the object is calculated using the capacitance value and the properties of the target object or is calculated using known positions to create a calibration factor.

Another common type of capacitance sensor uses conductive plates as a sensing electrode and a ground electrode to create a capacitance measuring pair. The electrodes in these systems can be coplanar or opposite each other. If the electrodes are opposite each other the material of interest is placed between the electrodes and the capacitance depends on the density of the material of interest, the composition of the material of interest, and thickness of the material of interest. If the electrodes are coplanar then the material of interest is placed in front of the electrodes and the capacitance depends on the distance the electrodes are from the material of interest, the composition of the material of interest, and the density of the material of interest.

Other types of capacitive probes use more than one coplanar sensing electrode to improve distance measurements. This type of capacitive sensor is disclosed in US Patent Application Publication US2020/0041311 A1 which consists of a sensor with multiple coplanar capacitive sensor elements used to measure the distance to an object. The additional electrodes compensation for tilt in the sensor and electrode fringe effects to improve the accuracy of distance readings. Another capacitive sensor of this type is disclosed in U.S. Pat. No. 4,183,060. This sensor uses two coplanar sensor electrodes to balance variations in the ground of the target of the measurement.

The problem using the disclosed and prior art capacitive distance sensors for measuring powder layers and inhomogeneous materials is that the measured capacitance depends on the distance the electrodes are from the material of interest, the composition of the material of interest, and the density of the material of interest. Powder layers do not have uniform or constant densities. This means that the distance measurement from a capacitive sensor will change both with the thickness of the powder layer and changes in the powder density. The distance measurement cannot be corrected for density changes in the powder layer because the density values change and are not known. This is also true for inhomogeneous materials where both the density and composition of the material can change.

Other types of distance sensors are optical and include laser triangulation sensors, light time of flight sensors, interferometers and optical microscopy techniques. Interferometers and microscopy techniques are expensive and can be slow. Time of flight sensors are currently not accurate enough to measure on the micrometer scale. Laser triangulation sensors are sensitive to light scattering of powder particles on the surface of the powder layer. All optical techniques lose accuracy with powder layers due to light scattering on the surface of the powder, light absorption and reflection that create noise on the light signal.

The present invention overcomes the problems with using capacitive sensors to measure powder layers and inhomogeneous materials and creates a simple, inexpensive and durable sensor to measure the thickness of powder and inhomogeneous materials.

### BRIEF SUMMARY OF THE INVENTION

The inventor of the present invention designed the instrument disclosed is U.S. Pat. No. 11,112,341 to measure the spreadability of powders for additive manufacturing applications. This instrument required a means of measuring the thickness of the layers of powder produced during spreadability tests. After considering and testing many commercially available sensors the inventor determined that none of them were entirely suitable for the application. Therefore, a new sensor design was required.

The invention is a capacitive distance sensor for measuring the thickness of micrometer scale powder layers and inhomogeneous materials. The sensor measures the distance between the sensor and the surface of the powder layer or material of interest. The sensor consists of an array of capacitive measuring electrode pairs with two or more measuring electrode pairs located at different distances from the surface of the powder layer or material of interest. The measuring electrode pairs are used in combination to measure the distance to the surface of the powder layer or material of interest independent of the density and material composition of the powder layer or material of interest. The distance to the surface of the powder layer or material of interest is calculated using the signals from capacitive measurement circuits connected to the measuring electrode pairs.

### BRIEF DESCRIPTION OF THE DRAWINGS

FIG. 1 presents a parallel plate capacitive sensor.

FIG. 2 presents a coplanar capacitive sensor.

FIG. 3 presents a coplanar capacitive sensor with guard electrode.

FIG. 4 presents a multiplanar capacitive sensor with guard electrodes.

FIG. 5 presents the preferred embodiment of the invention.

FIG. 6 presents a side view of the preferred embodiment of the invention.

FIG. 7 presents another embodiment of the invention.

### DETAILED DESCRIPTION OF THE INVENTION

The invention consists of a capacitive sensor consisting of a multiplanar array of capacitive measuring electrode pairs with two or more capacitive measuring electrode pairs located at different distances from the surface of the powder layer or material of interest that are used in combination to measure the distance to the surface of the powder layer or material of interest independent of the density and material composition of the powder layer or material of interest.

A typical capacitive distance sensor measures the change in capacitance that occurs when an object moves toward the sensor and calculates the distance to the sensor by multiplying the capacitance change by a calibration factor. Capacitance is the ability of a material or object to store electric charge. This ability is determined by the permittivity of the material or object which is a measure of the electric polarizability of the material or object. A measurement of relative permittivity is called the dielectric constant. Air has a dielectric constant of 1.00059. Other materials have different dielectric constants. Therefore, the reading of a sensor that measures capacitance in air changes as an object with a different dielectric constant than air nears it. This measurement changes more as the material or object gets closer to the sensor.

Capacitance measurements require a minimum of two objects that create an electrode pair. A simple capacitance sensor consists of a measuring electrode and a ground electrode. The ground electrode can be an actual electrode or the material to be measured. Capacitive distance sensors typically consist of one or more metal plates in either parallel plate geometry or coplanar geometry. Parallel plate sensors measure the capacitance of materials or objects that pass between the plates as in FIG. 1. A voltage on the measuring electrode 1 creates an electrostatic field between the measuring electrode and ground electrode 2. The electrostatic field in FIG. 1 is represented by electrostatic field lines 3.

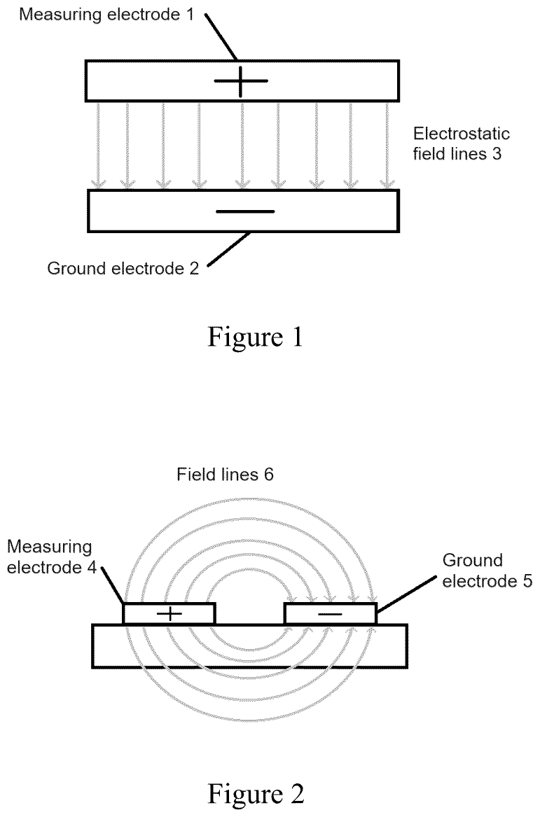

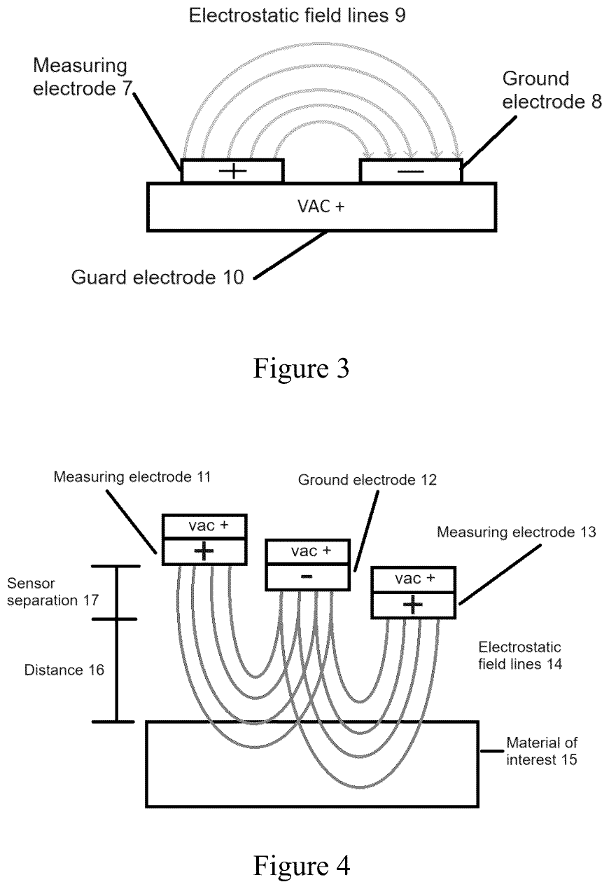

Coplanar sensors measure the capacitance of materials or objects that are in front of them on the principle of fringing capacitance. The fringing capacitive effect is developed between the electrodes with field lines extending beyond the sensor surface as in FIG. 2. An electrostatic field as represented by electrostatic field lines 6 develops around the measuring electrode 4 and ground electrode 5 when a voltage is applied to the measuring electrode 4. A guard electrode can direct the field lines in one direction in a coplanar geometry. FIG. 3 depicts the effect on the electrostatic files lines when a voltage is applied to guard electrode 10.

The problem with using a typical capacitive distance sensor to measure powder or inhomogeneous material layer thickness is that the capacitance values change with the distance to the powder layer or material of interest as well as with the density and chemical composition of the powder layer or material of interest. Powders are a blend of solid material and air, and each has a different dielectric constant. This means that the capacitance value of a powder layer will change depending on the ratio of powder material to air in the layer. The moisture level of the powder will also change the capacitance. Therefore, using a typical capacitance distance sensor to measure the powder layer thickness will only reveal the uniformity of the layer in terms of layer thickness, density, and chemical composition. A uniform layer will have a constant capacitance while a non-uniform layer will have a changing capacitance.

The invented sensor solves the issue with capacitance changing with several powder material parameters by using two or more multiplanar capacitive measuring electrode pairs placed at different distances to the powder layer or material of interest. The change in capacitance due to bed density and chemical composition will cause the same change in all of the measuring electrode pairs while the distance to the sensors will have a different change due to the difference in distance to the powder layer or material of interest.

FIG. 4 depicts the geometry of the invented sensor. Measuring electrode 11 and measuring electrode 13 form two electrode pairs with ground electrode 12. Each electrode pair is a different distance from the material of interest 15. The difference in distance from the material of interested to each sensor is called the sensor separation 17. The capacitance measured by both electrode pairs will change with the distance to the material of interest, the density of the material of interest and the chemical composition of the material of interest. However, the distance 16 measured by capacitive electrode 11 must equal the distance 16 measured by capacitive sensor 13 plus the sensor separation 17. This fact allows the distance to the material of interest to be calculated using the change in capacitance from both sensors independent of the density and chemical composition of the material of interest.

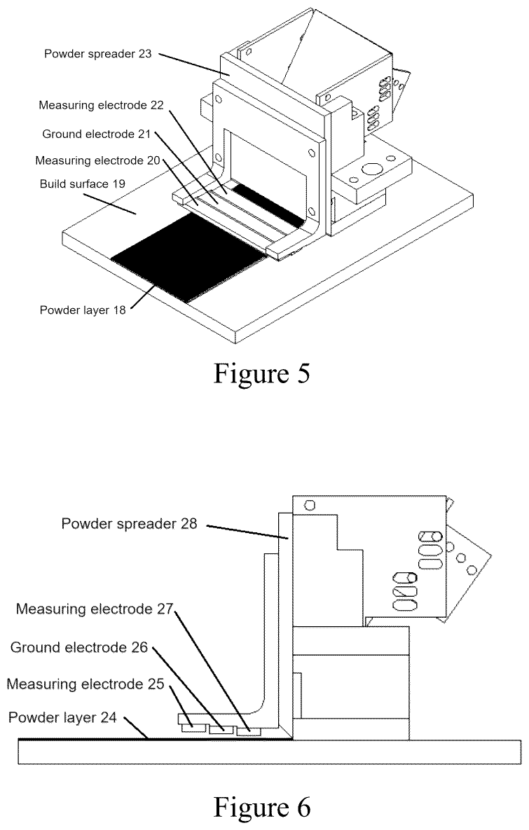

The preferred embodiment of the invention is shown in FIG. 5. Capacitive sensing electrodes 20 and 22 are mounted on a holder in a manner that they are different distances from the powder layer 18. Ground electrode 21 is placed between the two measuring electrodes. Each measuring electrode 20 and 22 and the ground electrode 21 create a measuring electrode pair giving the sensor two measuring pairs. The measuring electrodes 20 and 22 are close to each other and the ground electrode 21 so each electrode pair measures the same area of the target powder layer 19 or other material of interest. The sensor in this case is mounted to powder spreader 23 that spreads the powder layer 18 on build surface 19. The powder spreader 23 has relative motion to the powder layer 18 allowing the sensor to measure multiple layer locations over time. The capacitance readings from the measuring pairs can be timed to measure the exact same position of powder. The measuring electrodes 20 and 22 and ground electrode 21 are connected to measuring electronics which perform the measurement of the capacitance of each measuring electrode and ground pair. The sensor could also measure correctly if measuring electrodes 20 and 22 were switched, grounded and ground electrode 21 was converted to a measuring electrode. The side view of the preferred embodiment of the invention is shown in FIG. 6 to illustrate that the electrodes 25, 26 and 27 are different distances to the powder layer 22.

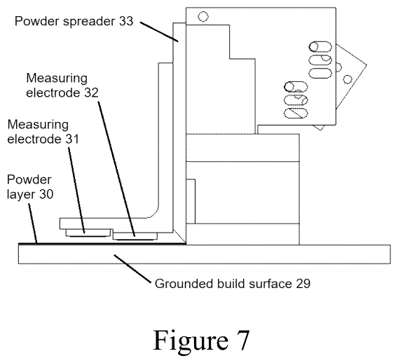

An additional embodiment of the invention is shown in FIG. 7. In this embodiment there are two measuring electrodes 31 and 32. The grounded build surface 29 creates the ground electrode to give the sensor two measuring electrode pairs in a parallel plate geometry relative to the measuring electrodes 31 and 32. This embodiment is suitable for measuring the powder layer thickness of powders spread on a conductive surface.

The thickness of the powder layer or material of interest can be calculated in many ways but must include the measurement of capacitance at different distances from the material of interest to be independent of the density and chemical composition of the material of interest. In the preferred embodiment of the invention the sensor is calibrated using a calibration factor calculated from the measured capacitances of the two electrode pairs when at a known distance from the build surface using Equation 1. The build surface distance is the known distance between the electrode pair closest to the build surface and the build surface. This distance is illustrated in FIG. 4 as Distance 16. The sensor separation is the difference in distance from the build surface to each measuring electrode pair. The sensor separation is illustrated in FIG. 4 as Sensor separation 17. Zero Lower is the capacitance of the sensor closest to the build surface and Zero Upper is the capacitance of the sensor farthest from the build surface when at a known distance from the build surface.

$$Calibration Factor calculation$$

$$Calibration Factor = \frac{Build surface distance}{Sensor Separation} \times \frac{Zero Lower}{Zero Upper} / ( 1 - \frac{Zero Upper}{Zero Lower} ) \qquad Equation 1$$

The thickness of the powder layer is calculated using Equation 2. The Cap Upper is the capacitance of the electrode pair farthest from the build surface and Cap Lower is the capacitance of the electrode pair closest to the build surface when over the powder layer or material of interest.

$$Layer Thickness calculation$$

$$Thickness = Calibration Factor \times Sensor Separation \times \frac{Cap Upper}{Cap Lower} / ( 1 - \frac{Cap Upper}{Cap Lower} ) \qquad Equation 2$$

Table 1 shows typical results from the preferred embodiment of the invention. The capacitive thickness is the thickness of powder layers created by a powder spreader calculated using the equations 1 and 2. The powder layers were created on a solid build surface with a powder spreader with a 275 μm spreading gap. The powders tested have very different dielectric constants and densities, but the thickness measurements are in the same range as the spreading gap even with the large change in dielectric constants and densities. Powders do not spread equally so it is expected that the thicknesses are not exactly the same as the spreading gap.

TABLE 1

| | Capacitive | | |
|---|---|---|---|
| | Thickness | Density | Dielectric |
| Sample | μm | g/cm³ | Constant |
| Ti—6Al—4V | 278 | 4.43 | 86-173 |
| AlSi10Mg | 273 | 2.7 | 1.6-1.8 |
| PA Polymer | 256 | 1.0 | 3.6 |

What is claimed is:

1. A capacitive sensor for measuring the thickness of powder layers or inhomogeneous materials comprising:
a) two or more capacitive measuring electrode pairs, each pair consisting of a measuring electrode and a ground electrode that are located in close proximity to a powder layer or material of interest so that the capacitance of each electrode pair is a function of the density, chemical composition, and distance to the powder layer or material of interest but are at different distances from the powder layer or material of interest;
b) a means of measuring the capacitance between the measuring electrode and ground electrode in each capacitance measuring electrode pair so that the capacitance of each capacitance measuring electrode pair can be used together to calculate the distance to the powder layer or material of interest independent of the density and chemical composition of the powder layer or material of interest.
